(19) United States
(12) Patent Application Publication
(10) Pub. No.: US 2009/0144668 A1
(43) Pub. Date: Jun. 4, 2009

(54) SENSING APPARATUS AND OPERATING METHOD THEREOF

(76) Inventor: Tse-Hsien YEH, Taipei City (TW)

Correspondence Address: BIRCH STEWART KOLASCH & BIRCH, PO BOX 747, FALLS CHURCH, VA, 22040-0747, US

(21) Appl. No.: 12/326,592

(22) Filed: Dec. 2, 2008

Related U.S. Application Data
(60) Provisional application No. 60/991,991, filed on Dec. 3, 2007.

(51) Int. Cl. G06F 3/033; G06K 9/00

(52) U.S. Cl. 715/863; 382/154

(57) ABSTRACT

A sensing apparatus is disclosed. The sensing apparatus comprises a first image capturing module, a second image capturing module, a calculating module, and a controlling module. The first image capturing module and the second image capturing module capture a first image and a second image related to a plurality of objects respectively at a specific time. The calculating module obtains a 3-D position of an object according to the first image and the second image and obtains a 3-D displacement of the object according to the 3-D position and a former 3-D position of the object. If any one of 3-D displacements corresponding to the objects is approximately vertical, the controlling module controls an electrical apparatus to perform a first function. If a weighting average of approximately horizontal vector components of all 3-D displacements meets a condition, the controlling module controls the electrical apparatus to perform a second function.

### BACKGROUND OF THE INVENTION

1. Field of the Invention

The invention relates to a sensing apparatus, and more particularly, to a sensing apparatus capable of sensing a plurality of objects and operating an electrical apparatus according to the moving states of the plurality of objects and a method of operating the sensing apparatus.

2. Description of the Prior Art

In recent years, with the continue progression of technology, the development of various kinds of information processing apparatus is also rapid. Because the notebook has many advantages such as its small size and it is easy to be carried, the notebook has gradually become one of the most-used information processing apparatus in modem daily life.

In general, a user usually operates a mouse to control a cursor shown on the monitor of the notebook to move in a certain direction, to click a certain function, or to scroll a reel of a window. However, if the user forgets to bring a mouse with him/her or the user is at an inconvenient position so that he/she can not operate the mouse, it will be a real trouble for the user.

Therefore, the invention provides a sensing apparatus and a method of operating the sensing apparatus to solve the above-mentioned problems.

### SUMMARY OF THE INVENTION

The invention provides a sensing apparatus capable of sensing a plurality of objects and operating an electrical apparatus according to the moving states of the plurality of objects and a method of operating the sensing apparatus.

A first embodiment of the invention is a sensing apparatus. In this embodiment, the sensing apparatus comprises a first image capturing module, a second image capturing module, a calculating module, and a controlling module, wherein the calculating module is coupled to the first image capturing module, the second image capturing module, and the controlling module respectively.

At a specific time, the first image capturing module captures a first image related to a plurality of objects and the second image capturing module captures a second image related to the plurality of objects. Then, the calculating module will obtain a 3-D (three-dimensional) position of an object among the plurality of objects according to the first image and the second image, and obtain a 3-D displacement of the object according to the 3-D position of the object and a former 3-D position of the object.

In practical applications, if any one of the 3-D displacements corresponding to the plurality of objects is approximately vertical, the controlling module will control an electrical apparatus to perform a first function; if a weighting average of approximately horizontal vector components of all 3-D displacements meets a condition, the controlling module controls the electrical apparatus to perform a second function. And, the first function can be a function to simulate pressing at least one functional key of a mouse; the second function can be a function to simulate the movement of a mouse.

In addition, the former 3-D position of the object is calculated according to a first former image and a second former image. The first former image and the second former image are related to the plurality of objects and captured by the first image capturing module and the second image capturing module respectively at a former time earlier than the specific time.

A second embodiment of the invention is a sensing apparatus operating method. At first, the method captures a first image and a second image related to a plurality of objects at a specific time. Then, the method obtains a 3-D position of an object among the plurality of objects according to the first image and the second image and obtains a 3-D displacement of the object according to the 3-D position of the object and a former 3-D position of the object.

In this embodiment, if any one of the 3-D displacements corresponding to the plurality of objects is approximately vertical, the method controls an electrical apparatus to perform a first function; if a weighting average of approximately horizontal vector components of all 3-D displacements meets a condition, the controlling module controls the electrical apparatus to perform a second function. In fact, the first function can be a function to simulate pressing at least one functional key of a mouse; the second function can be a function to simulate the movement of a mouse.

A third embodiment of the invention is a sensing apparatus. In this embodiment, the sensing apparatus comprises a first image capturing module, a second image capturing module, a calculating module, and a controlling module, wherein the calculating module is coupled to the first image capturing module, the second image capturing module, and the controlling module respectively.

In this embodiment, the first image capturing module is used for capturing a first image related to the plurality of objects at a first time and a second image related to a plurality of objects at a second time respectively; the second image capturing module is used for capturing a third image related to the plurality of objects at the first time and a fourth image related to the plurality of objects at the second time respectively. The calculating module obtains a first 2-D (two-dimensional) displacement of an object among the plurality of objects according to the first image and the second image and obtains a second 2-D displacement of the object according to the third image and the fourth image, then the calculating module obtains a 3-D displacement of the object according to the first 2-D displacement and the second 2-D displacement of the object. If any one of the 3-D displacements corresponding to the plurality of objects is approximately vertical, the controlling module controls an electrical apparatus to perform a first function; if a weighting average of approximately horizontal vector components of all 3-D displacements meets a condition, the controlling module controls the electrical apparatus to perform a second function.

A fourth embodiment of the invention is a sensing apparatus operating method. At first, the method captures a first image and a second image at a first time and captures a third image and a fourth image at a second time. The first image, the second image, the third image, and the fourth image are all related to the plurality of objects. The first image and the third image are captured by the first image capturing module; the second image and the fourth image are captured by the second image capturing module.

Then, the method obtains a first 2-D displacement of an object among the plurality of objects according to the first image and the third image and obtains a second 2-D displacement of the object according to the second image and the fourth image. Afterward, the method obtains a 3-D displacement of the object according to the first 2-D displacement and the second 2-D displacement of the object.

In this embodiment, if any one of the 3-D displacements corresponding to the plurality of objects is approximately vertical, the method controls an electrical apparatus to perform a first function; if a weighting average of approximately horizontal vector components of all 3-D displacements meets a condition, the controlling module controls the electrical apparatus to perform a second function. In fact, the first function can be a function to simulate pressing at least one functional key of a mouse; the second function can be a function to simulate the movement of a mouse.

Compared with the prior art, because the sensing apparatus and operating method thereof according to the invention can sense the moving states of a plurality of objects to operate an electrical apparatus, the notebook users can easily use their hand motions ordinarily used to operate a mouse to control a cursor shown on the monitor of the electrical apparatus to perform corresponding functions without the mouse. Furthermore, the sensing apparatus and operating method thereof can be widely used in other regions.

The advantage and spirit of the invention may be further understood by the following recitations together with the appended drawings.

### BRIEF DESCRIPTION OF THE APPENDED DRAWINGS

FIG. 1 shows a functional block diagram of the sensing apparatus in the first embodiment according to the invention.

FIG. 2(A)˜FIG. 2(C) show scheme diagrams of the sensing apparatus set on a notebook in different setting ways.

FIG. 3 shows a flowchart of the sensing apparatus operating method in the second embodiment according to the invention.

FIG. 4 shows a functional block diagram of the sensing apparatus in the third embodiment according to the invention.

FIG. 5 shows a flowchart of the sensing apparatus operating method in the fourth embodiment according to the invention.

### DETAILED DESCRIPTION OF THE INVENTION

The main scope of the invention is to provide a sensing apparatus and a sensing apparatus operating method capable of sensing the moving states of a plurality of objects to operate an electrical apparatus. Thus, the users only need to simulate the motions of operating a mouse, and the sensing apparatus will automatically control the electrical apparatus to perform the corresponding functions according to the motions.

A first embodiment according to the invention is a sensing apparatus. In this embodiment, the sensing apparatus is coupled to a notebook (but it is not limited by this case), and it is used for sensing the moving states of a plurality of objects (e.g., a user's fingers) and operating the notebook according to these moving states,

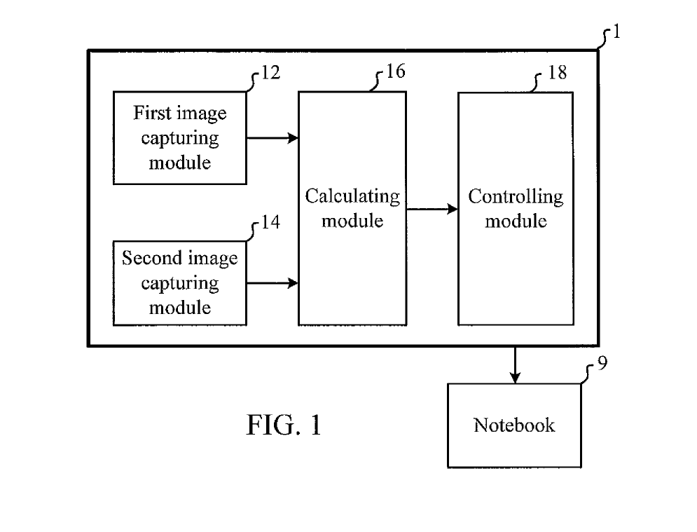

Please refer to FIG. 1. FIG. 1 shows a functional block diagram of the sensing apparatus. As shown in FIG. 1, the sensing apparatus 1 comprises a first image capturing module 12, a second image capturing module 14, a calculating module 16, and a controlling module 18, wherein the calculating module 16 is coupled to the first image capturing module 12, the second image capturing module 14, and the controlling module 18 respectively; the signal transmission between the controlling module 18 and the notebook 9 can be performed in a wire/wireless way.

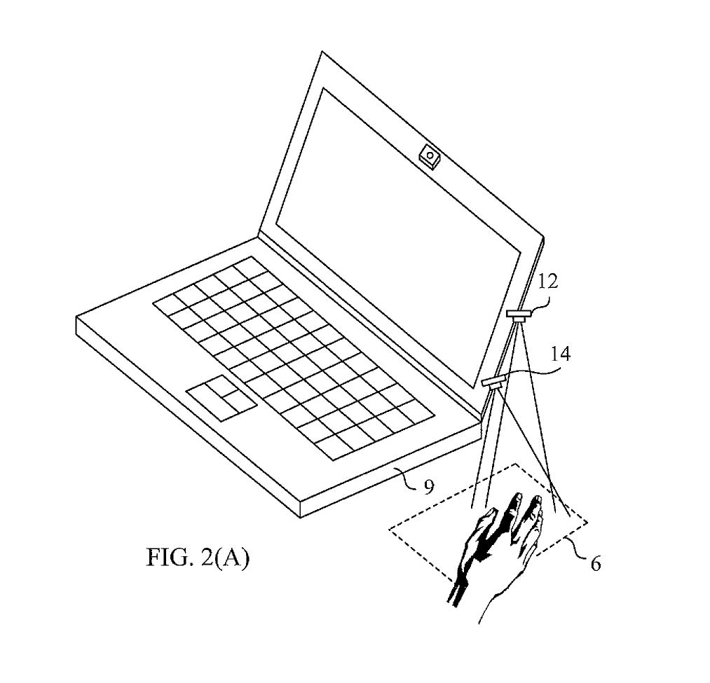

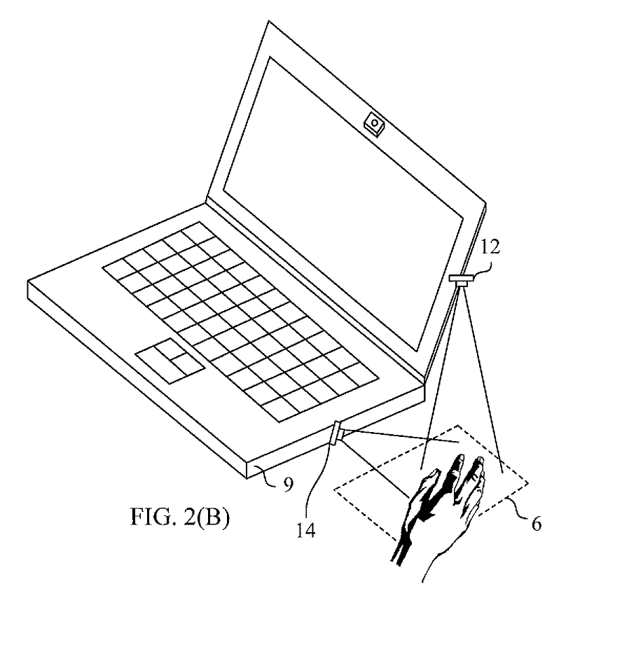

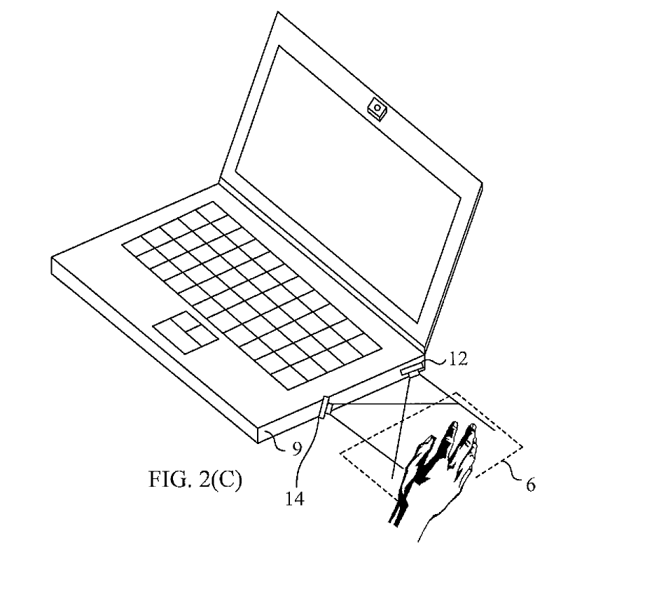

In fact, the first image capturing module 12 and the second image capturing module 14 can be set at different positions on one side of the notebook 9, and a fixed distance is existent between the first image capturing module 12 and the second image capturing module 14. In FIG. 2(A) to FIG. 2(C), three different setting ways for setting the first image capturing module 12 and the second image capturing module 14 on the notebook 9 are shown. However, there are still lots of other setting ways, not limited by the above-mentioned cases. For example, because the ordinary user uses his/her right-hand to operate the mouse (but it is not limited by this case), the first image capturing module 12 and the second image capturing module 14 can be set at different positions on the right side of the notebook 9, so that the image of the right-hand motions of the user can be captured by the first image capturing module 12 and the second image capturing module 14 in two different angles.

In addition, because the first image capturing module 12 and the second image capturing module 14 are used to take pictures related to the hand motions of the user, a specific region 6 can be set by the side of the right side of the notebook 9, so that the user can use his/her right-hand to generate motions in this specific region. Therefore, the first image capturing module 12 and the second image capturing module 14 can aim at this specific region and take pictures related to the hand motions of the user.

In practical applications, the first image capturing module 12 and the second image capturing module 14 can be a camera, a video-camera, or any other apparatus capable of capturing images. Therefore, the first image capturing module 12 and the second image capturing module 14 can belong to different kinds or types. In addition, the first image capturing module 12 and the second image capturing module 14 can comprise lens. And, the types and the numbers of the lens are not limited, so the first image capturing module 12 and the second image capturing module 14 can comprise no lens.

In this embodiment, the first image capturing module 12 and the second image capturing module 14 will capture a first image and a second image related to a plurality of objects respectively at a specific time. That is to say, at a certain time, the two cameras set at different positions on the right side of the notebook 9 will take images comprising the right-hand fingers of the user in different angles.

Then, the calculating module 16 will obtain a 3-D position of an object among the plurality of objects according to the first image and the second image, and obtain a 3-D displacement of the object according to the 3-D position and a former 3-D position of the object. That is to say, after the two cameras take two images related to the right-hand fingers of the user in different angles, the calculating module 16 will calculate the 3-D position of each object in the image, and obtain the 3-D displacement of each object according to the 3-D position and former 3-D position of each object.

In this embodiment, the former 3-D position of each object is calculated by the calculating module 16 according to a first former image and a second former image. The first former image and the second former image are related to the plurality of objects and captured by the first image capturing module 12 and the second image capturing module 14 respectively at a former time earlier than the specific time.

After the 3-D displacement of each object is calculated by the calculating module 16, if these 3-D displacements can meet a certain specific condition, the controlling module 18 will perform a certain specific function. In fact, the corresponding relationship between the specific conditions and the specific functions can be default or set by the user according to his/her habit or favorite. It has no fixed limitations. In general, when the user operates a mouse, the user will probably hold the mouse and move the mouse horizontally or press the functional keys of the mouse vertically, but it is not limited by this case.

For example, if any one of the 3-D displacements corresponding to the plurality of objects is approximately vertical, namely any right-hand finger of the user generates a motion of pressing the functional key of the mouse (e.g., moving upward and downward in a vertical direction), the controlling module 18 will transmit a controlling signal to the notebook 9 in a wire/wireless way to control the notebook 9 to perform a function of simulating pressing the functional key of the mouse (e.g, simulating the click function corresponding to the motion of pressing the left key of the mouse); if a weighting average of approximately horizontal vector components of all 3-D displacements meets a condition (e.g., all of the right-hand fingers generate a motion of holding the mouse and moving the mouse horizontally, so that a weighting average of all 3-D displacements corresponding to the objects is approximately horizontal), the controlling module 18 will transmit a controlling signal to the notebook 9 in a wire/wireless way to control the notebook 9 to perform a function of simulating the movement of the mouse, for example, simulating a function of moving the mouse cursor shown on the monitor to the left when the user holds the mouse and moves the mouse horizontally.

In fact, a weight value corresponding to each 3-D displacement can be a default value or set up by a user, that is to say, each 3-D displacement can correspond to different weight values. For example, a user can set up different weight values for different fingers according to his/her practical requirement or favorite.

In this embodiment, the above-mentioned “approximately horizontal” or “approximately vertical” corresponds to a reference orientation (e.g., the setting orientation of the base of the notebook 9). Namely, if a direction is approximately parallel to the reference orientation, the direction is then called “approximately horizontal”; if a direction is approximately vertical to the reference orientation, the direction is then called “approximately vertical”. However, the reference orientation can be a default orientation or set up by the user, not limited by this case.

It should be noticed that when the user uses a mouse, the movement is not necessary to be horizontal or vertical. Therefore, “approximately horizontal” or “approximately vertical” is used as a judging standard in this invention to give an flexible space for practical applications.

In practical applications, the sensing apparatus 1 can further comprise a lighting module (not shown in the figures). The lighting module can be any lighting apparatus (e.g., a LED light), and it can be activated and emit a light when the environment of the user is dark, so that the first image capturing module 12 and the second image capturing module 14 can capture the images more smoothly.

In addition, the calculating module 16 and/or the controlling module 18 of the sensing apparatus 1 can be realized in a hardware way and/or a software way and has no fixed limitations. For example, after the basic calculating functions are performed by the calculating module 16 and/or the controlling module 18 of the sensing apparatus 1, a controlling signal will be transmitted to the notebook 9. Then, the CPU of the notebook 9 will perform the following signal processing procedures. That is to say, the calculating module 16 and/or the controlling module 18 can be realized in different ways, not limited by the above-mentioned cases.

Above all, the user can use the sensing apparatus to smoothly control the cursor shown on the monitor of the notebook and perform the corresponding functions by generating the hand motions used to operate the mouse as usual. Therefore, even the user forgets to bring the mouse with him/her or it is inconvenient to use the mouse at the position of the user, the user can still simulate the function of the mouse via the sensing apparatus.

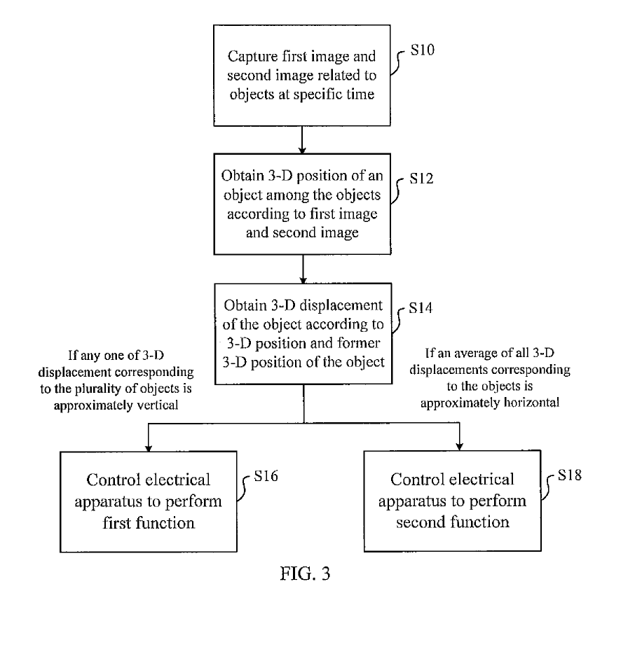

A second embodiment of the invention is a sensing apparatus operating method. The sensing apparatus is used for sensing a plurality of objects and operating an electrical apparatus according to the moving states of the plurality of objects. In fact, the electrical apparatus can be a notebook or any other apparatus capable of processing information. Please refer to FIG. 3. FIG. 3 shows a flowchart of the sensing apparatus operating method.

As shown in FIG. 3, at first, the method performs step S10 to capture a first image and a second image related to a plurality of objects at a specific time. Then, the method performs step S12 to obtain a 3-D position of an object among the plurality of objects according to the first image and the second image. Afterward, the method performs step S 14 to obtain a 3 -D displacement of the object according to the 3-D position and a former 3-D position of the object.

In fact, the former 3-D position of the object is calculated according to a first former image and a second former image, the first former image and the second former image are related to the plurality of objects and captured at a former time earlier than the specific time.

In this embodiment, if these 3-D displacements can meet a certain specific condition, the method will control an electrical apparatus to perform a certain specific function. For example, if any one of the 3-D displacements corresponding to the plurality of objects is approximately vertical, the method will perform step S16 to control the electrical apparatus to perform a first function; if a weighting average of approximately horizontal vector components of all 3-D displacements meets a condition (e.g., a weighting average of all 3-D displacements corresponding to the objects is approximately horizontal), the method will perform step S18 to control the electrical apparatus to perform a second function.

In fact, the first function can be a function to simulate pressing at least one functional key of the mouse; the second function can be a function to simulate the movement of the mouse, but it is not limited by this case. In addition, a weight value corresponding to each 3-D displacement can be a default value or set up by a user, that is to say, each 3-D displacement can correspond to different weight values.

It should be noticed that the specific condition can be that the weighting average equals to a specific value or the weighting average is in a certain specific range, or any other conditions, and the specific condition can be default or set by the user, not limited by the above-mentioned cases.

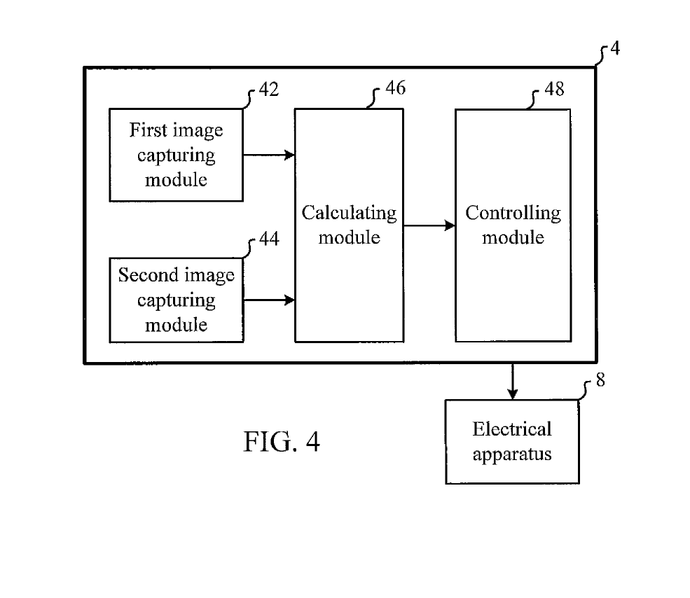

A third embodiment of the invention is a sensing apparatus. In this embodiment, the sensing apparatus is coupled to an electrical apparatus and used for sensing a plurality of objects and operating an electrical apparatus according to the moving states of the plurality of objects. In fact, the electrical apparatus can be a notebook or any other apparatus capable of processing information. Please refer to FIG. 4. FIG. 4 shows a functional block diagram of the sensing apparatus.

As shown in FIG. 4, the sensing apparatus 4 comprises a first image capturing module 42, a second image capturing module 44, a calculating module 46, and a controlling module 48, wherein the calculating module 46 is coupled to the first image capturing module 42, the second image capturing module 44, and the controlling module 48 respectively; the signal transmission between the controlling module 48 and the electrical apparatus 8 can be performed via a wire or in a wireless way.

In fact, the first image capturing module 42 and the second image capturing module 44 can be set at different positions on one side of the electrical apparatus 8, and a fixed distance is between the first image capturing module 42 and the second image capturing module 44. In addition, a specific region can be set by the side of the right side of the electrical apparatus 8, so that the user can use his/her right-hand to generate motions in this specific region. Therefore, the first image capturing module 42 and the second image capturing module 44 can aim at this specific region and take pictures related to the hand motions of the user.

In practical applications, the first image capturing module 42 and the second image capturing module 44 can be a camera, a video-camera, or any other apparatus capable of capturing images. Therefore, the first image capturing module 42 and the second image capturing module 44 can belong to different kinds or types. In addition, the first image capturing module 42 and the second image capturing module 44 can comprise lens. And, the types and the numbers of lens are not limited, so the first image capturing module 42 and the second image capturing module 44 can comprise no lens.

In this embodiment, the first image capturing module 42 is used for capturing a first image related to the plurality of objects at a first time and a second image related to the plurality of objects at a second time respectively; the second image capturing module 44 is used for capturing a third image related to the plurality of objects at the first time and a fourth image related to the plurality of objects at the second time respectively.

The largest difference between this embodiment and the first embodiment is that the calculating module 46 in this embodiment will firstly obtain the first 2-D displacement of each object according to the first image and the second image captured by the first image capturing module 42 at different time, and obtain the second 2-D displacement of each object according to the third image and the fourth image captured by the second image capturing module 44 at different time. Then, the calculating module 46 will obtain the 3-D displacement of each object according to the first 2-D displacement and the second 2-D displacement of each object.

After the 3-D displacement of each object is calculated by the calculating module 46, if these 3-D displacements can meet a certain specific condition, the controlling module 48 will perform a certain specific function. In fact, the corresponding relationship between the specific conditions and the specific functions can be default or set by the user with his/her habit or favorite. It has no fixed limitations.

In practical applications, the sensing apparatus 4 can farther comprise a lighting module (not shown in the figures). The lighting module can be any lighting apparatus, and it can be activated and emit a light when the environment of the user is dark, so that the first image capturing module 42 and the second image capturing module 44 can capture the images more smoothly.

In addition, the calculating module 46 and/or the controlling module 48 of the sensing apparatus 4 can be realized in a hardware way and/or a software way and has no fixed limitations. For example, after the basic calculating functions are performed by the calculating module 46 and/or the controlling module 48 of the sensing apparatus 4, a controlling signal will be transmitted to the electrical apparatus 8. Then, the electrical apparatus 8 will perform the following signal processing procedures. That is to say, the calculating module 46 and/or the controlling module 48 can be realized in different ways, not limited by the above-mentioned cases.

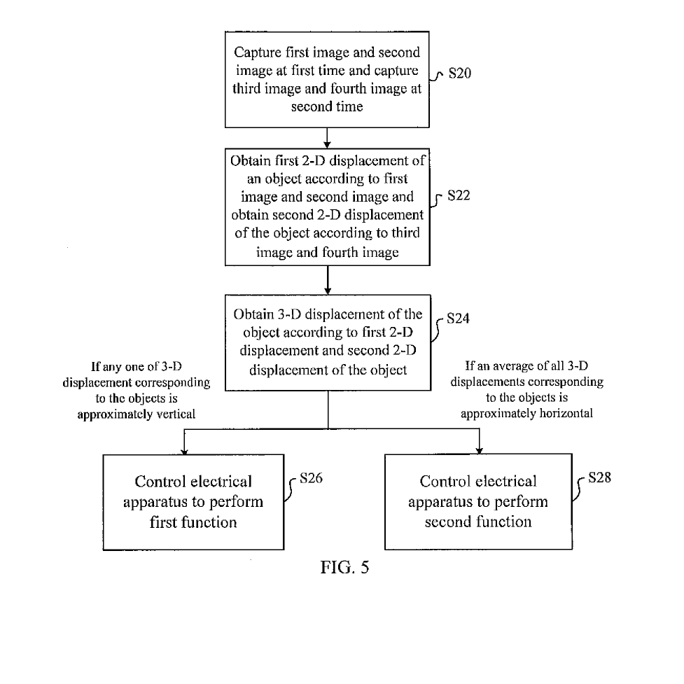

A fourth embodiment of the invention is a sensing apparatus operating method. The sensing apparatus is used for sensing a plurality of objects and operating an electrical apparatus according to the moving states of the plurality of objects. In fact, the electrical apparatus can be a notebook or any other apparatus capable of processing information. Please refer to FIG. 5, FIG. 5 shows a flowchart of the sensing apparatus operating method.

As shown in FIG. 5, at first, the method performs step S20 to capture a first image and a second image at a first time and capture a third image and a fourth image at a second time, wherein the first image, the second image, the third image, and the fourth image are all related to the plurality of objects. The first image and the third image are captured by the first image capturing module; the second image and the fourth image are captured by the second image capturing module.

Then, the method performs step S22 to obtain a first 2-D displacement of an object among the plurality of objects according to the first image and the third image and obtain a second 2-D displacement of the object according to the second image and the fourth image. Afterward, the method performs step S24 to obtain a 3-D displacement of the object according to the first 2-D displacement and the second 2-D displacement of the object.

That is to say, the largest difference between this embodiment and the second embodiment is that the method in this embodiment will firstly obtain the first 2-D displacement of each object according to the first image and the second image captured by the first image capturing module at different time, and obtain the second 2-D displacement of each object according to the third image and the fourth image captured by the second image capturing module at different time. Then, the method will obtain the 3-D displacement of each object according to the first 2-D displacement and the second 2-D displacement of each object.

In practical applications, if any one of the 3-D displacements corresponding to the plurality of objects is approximately vertical, the method will perform step S26 to control the electrical apparatus to perform a first function; if a weighting average of approximately horizontal vector components of all 3-D displacements meets a condition, the method will perform step S28 to control the electrical apparatus to perform a second function.

In fact, the first function can be a function to simulate pressing at least one functional key of the mouse; the second function can be a function to simulate the movement of the mouse, but it is not limited by this case. In addition, a weight value corresponding to each 3-D displacement can be a default value or set up by a user, that is to say, each 3-D displacement can correspond to different weight values.

It should be noticed that the specific condition can be that the weighting average equals to a specific value or the weighting average is in a certain specific range, or any other conditions, and the specific condition can be default or set by the user, not limited by the above-mentioned cases.

Compared with the prior art, because the sensing apparatus and the sensing apparatus operating method according to the invention can sense the moving states of a plurality of objects to operate an electrical apparatus, the users can easily use their hand motions ordinarily used to operate a mouse to control a cursor shown on the monitor of the electrical apparatus to perform corresponding functions without the mouse. Furthermore, the sensing apparatus and the sensing apparatus operating method can be widely used in other regions.

With the recitations of the preferred embodiment above, the features and spirits of the invention will be hopefully well described. However, the scope of the invention is not restricted by the preferred embodiment disclosed above. The objective is that all alternative and equivalent arrangements are hopefully covered in the scope of the appended claims of the invention. Accordingly, the above disclosure should be construed as limited only by the metes and bounds of the appended claims.

What is claimed is:

1. A sensing apparatus, used for sensing a plurality of objects and operating an electrical apparatus according to the moving states of the plurality of objects, the sensing apparatus comprising:
a first image capturing module for capturing a first image related to the plurality of objects at a specific time;
a second image capturing module for capturing a second image related to the plurality of objects at the specific time;
a calculating module, coupled to the first image capturing module and the second image capturing module, for obtaining a 3-D position of an object among the plurality of objects according to the first image and the second image and obtaining a 3-D displacement of the object according to the 3-D position of the object and a former 3-D position of the object; and
a controlling module coupled to the calculating module, if a specific condition related to the 3-D displacements corresponding to the plurality of objects is satisfied, the controlling module controlling the electrical apparatus to perform a first function.

2. The sensing apparatus of claim 1, wherein the first function is to simulate pressing at least one functional key of a mouse.

3. The sensing apparatus of claim 1, wherein the specific condition is that any one of the 3-D displacements corresponds to a specific direction which is approximately vertical.

4. The sensing apparatus of claim 1, wherein if the specific condition is that an average of approximately horizontal vector components of all 3-D displacements meets a condition, the controlling module controls the electrical apparatus to perform a second function, and the second function is to simulate the movement of a mouse.

5. The sensing apparatus of claim 4, wherein the average is a weighting average, a weight value corresponding to each 3-D displacement is a default value or set up by a user, each 3-D displacement can correspond to different weight values, the condition is default or set up by the user.

6. The sensing apparatus of claim 1, wherein the former 3-D position of the object is calculated according to a first former image and a second former image, the first former image and the second former image are related to the plurality of objects and captured by the first image capturing module and the second image capturing module respectively at a former time earlier than the specific time.

7. A method of operating a sensing apparatus, the sensing apparatus being used for sensing a plurality of objects and operating an electrical apparatus according to the moving states of the plurality of objects, the method comprising the steps of:
capturing a first image and a second image related to the plurality of objects at a specific time;
obtaining a 3-D position of an object among the plurality of objects according to the first image and the second image;
obtaining a 3-D displacement of the object according to the 3-D position of the object and a former 3-D position of the object; and
controlling the electrical apparatus to perform a first function if a specific condition related to the 3-D displacements corresponding to the plurality of objects is satisfied.

8. The method of claim 7, wherein the first function is to simulate pressing at least one functional key of a mouse.

9. The method of claim 7, wherein the specific condition is that any one of the 3-D displacements corresponds to a specific direction which is approximately vertical.

10. The method of claim 7, wherein if the specific condition is that a weighting average of approximately horizontal vector components of all 3-D displacements meets a condition, the method further comprising the step of:
controlling the electrical apparatus to perform a second function;
wherein the second function is to simulate the movement of a mouse, a weight value corresponding to each 3-D displacement is a default value or set up by a user, each 3-D displacement can correspond to different weight values, the condition is default or set up by the user.

11. The method of claim 7, wherein the former 3-D position of the object is calculated according to a first former image and a second former image, the first former image and the second former image are related to the plurality of objects and captured at a former time earlier than the specific time.

12. A sensing apparatus, used for sensing a plurality of objects and operating an electrical apparatus according to the moving states of the plurality of objects, the sensing apparatus comprising:
a first image capturing module for capturing a first image related to the plurality of objects at a first time and a second image related to the plurality of objects at a second time respectively;
a second image capturing module for capturing a third image related to the plurality of objects at the first time and a fourth image related to the plurality of objects at the second time respectively;
a calculating module, coupled to the first image capturing module and the second image capturing module, the calculating module obtaining a first 2-D displacement of an object among the plurality of objects according to the first image and the second image and obtaining a second 2-D displacement of the object according to the third image and the fourth image, then the calculating module obtaining a 3-D displacement of the object according to the first 2-D displacement and the second 2-D displacement of the object; and
a controlling module coupled to the calculating module, if a specific condition related to the 3-D displacements corresponding to the objects is satisfied, the controlling module controlling the electrical apparatus to perform a first function.

13. The sensing apparatus of claim 12, wherein the first function is to simulate pressing at least one functional key of a mouse.

14. The sensing apparatus of claim 12, wherein the specific condition is that any one of the 3-D displacements corresponds to a specific direction which is approximately vertical.

15. The sensing apparatus of claim 12, wherein if the specific condition is that a weighting average of approximately horizontal vector components of all 3-D displacements meets a condition, the controlling module controls the electrical apparatus to perform a second function, and the second function is to simulate the movement of a mouse, a weight value corresponding to each 3-D displacement is a default value or set up by a user, each 3-D displacement can correspond to different weight values, the condition is default or set up by the user.

16. A method of operating a sensing apparatus, the sensing apparatus being used for sensing a plurality of objects and operating an electrical apparatus according to the moving states of the plurality of objects, the sensing apparatus comprising a first image capturing module and a second image capturing module, the method comprising the steps of:
capturing a first image and a second image at a first time and capturing a third image and a fourth image at a second time, wherein the first image, the second image, the third image, and the fourth image are all related to the plurality of objects, the first image and the third image are captured by the first image capturing module, the second image and the fourth image are captured by the second image capturing module;
obtaining a first 2-D displacement of an object among the plurality of objects according to the first image and the third image;
obtaining a second 2-D displacement of the object according to the second image and the fourth image;
obtaining a 3-D displacement of the object according to the first 2-D displacement and the second 2-D displacement of the object; and
controlling the electrical apparatus to perform a first function if a specific condition related to the 3-D displacements corresponding to the objects is satisfied.

17. The method of claim 16, wherein the first function is to simulate pressing at least one functional key of a mouse.

18. The method of claim 16, wherein the specific condition is that any one of the 3-D displacements corresponds to a specific direction which is approximately vertical.

19. The method of claim 16, wherein if the specific condition is that a weighting average of approximately horizontal vector components of all 3 -D displacements meets a condition, the method further comprising the step of:
controlling the electrical apparatus to perform a second function;
wherein the second function is to simulate the movement of a mouse, a weight value corresponding to each 3-D displacement is a default value or set up by a user, each 3-D displacement can correspond to different weight values, the condition is default or set up by the user.
